(19) United States
(12) Patent Application Publication
(10) Pub. No.: US 2008/0123102 A1
(43) Pub. Date: May 29, 2008

(54) Apparatus and method for measuring spacing

(75) Inventors: Masao Fujita, Osaka (JP); Toshio Kawakita, Osaka (JP); Shinji Kawakami, Osaka (JP); Sadamu Kuse, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/717,672

(22) Filed: Mar. 14, 2007

(30) Foreign Application Priority Data
Mar. 15, 2006 (JP) 2006-070891

(51) Int. Cl. G01B 9/02; G01B 11/02

(52) U.S. Cl. 356/486; 356/498

(57) ABSTRACT

An apparatus is provided for measuring a spacing between an object to be measured T and a transparent object 4. The transparent object 4 is disposed, facing a surface of the object to be measured T, light is emitted to impinge through the transparent object 4 onto the object to be measured T, and the spacing is calculated based on an intensity of interference light occurring in a facing portion between the surface of the object to be measured T and the transparent object 4. The apparatus comprises a light source 1 for emitting light, a modulator 2 for modulating an intensity of the emitted light with modulation waves having a predetermined frequency, a sensor 7 for converting the light intensity of the interference light into an electrical signal, and a synchronous demodulator 8 for subjecting the electrical signal to synchronous demodulation using the modulation waves as reference waves.

### BACKGROUND OF THE INVENTION

1. Field of the Invention

The present invention relates to an apparatus and a method for measuring a spacing between an object to be measured and a transparent object. More particularly, the present invention relates to an apparatus and a method for measuring a minute spacing between, for example, a magnetic head and a magnetic recording medium.

2. Description of the Related Art

In recent years, a spacing between a magnetic recording medium (e.g., a hard disk, a magnetic tape, etc.) and a head has been decreased with an increase in the recording density of the magnetic recording medium. Recently, in some case, the spacing is as minute as 5 to 10 nm.

Magnetic tapes have various applications, such as audio tapes, video tapes, computer tapes, and the like. Particularly, in the field of data backup tapes, as the capacity of a hard disk to be backed up is increased, tapes having a storage capacity of several hundreds of gigabytes per roll have been on the market. In the future, the capacity of the backup tape will be unavoidably increased so as to support the increasing capacity of hard disks.

Also, it is essentially required to increase a relative speed of a magnetic tape and a head so as to increase an access speed and a transfer rate.

Also, in order to increase the recording density of a magnetic tape, a system employing, as a signal reproduction head, an MB (magnetoresistance effect) head which causes a current to flow through a magnetoresistance effect film and detects a change in the resistance as a voltage, is used instead of a system employing a conventional electromagnetic induction type (inductive) magnetic head. The output of the MR head can be increased by designing a film having a large change in resistance of the element, a current density, and a head structure.

In the system employing the MR head, since an electromagnetic induction type head is generally employed for recording, an inductive/MR compound head in which a recording head and a reproduction head are integrated together is employed.

In order to increase the storage capacity per roll and support the high relative speed of a magnetic tape and a head as described above, there are two types of magnetic tapes: one in which the recording density is increased (the recording wavelength, and the track width are reduced) by modifying a magnetic layer by improving the magnetic characteristics and dispersibility of ferromagnetic powder; and the other in which the recording capacity is increased by increasing the tape length per roil by reducing the total thickness of the tape. In addition to these, it has been required to improve contact between a magnetic tape and a head by optimizing the mechanical characteristics of a non-magnetic support, an undercoat layer, and a magnetic layer.

In such a background, spacing measuring apparatuses have been proposed which measure a spacing between a magnetic tape and a head. The spacing measuring apparatus is generally based on white-light interferometry, in which a transparent object (simulated head) formed of a light transmitting material is disposed, facing a magnetic tape, and the intensity of interference light at the facing portion is measured.

FIG. 7 is a diagram showing an exemplary configuration of a conventional spacing measuring apparatus. Light emitted from a light source 100 is passed through an optical lens 101a and is then beat by 90 degrees by a half mirror 102. The bent light is passed through an optical lens 101b and is then brought through a simulated head 103 onto a magnetic tape T.

Interference light between reflected light from a surface facing the magnetic tape T of the simulated head 103 and reflected light from the magnetic tape T is transferred through the optical lens 101b, the half mirror 102, and an optical lens 101c to a CCD camera 104 (sensor). The interference light, which has reached the CCD camera 104, is converted into an electrical signal, which is input to an operation apparatus 105. In the operation apparatus 105, based on a relational expression between interference light intensities and spacings, a spacing h corresponding to a interference light intensity which is based on an input electrical signal is calculated.

By using the apparatus employing this method, a spacing of as small as about 150 nm can be relatively correctly measured. However, it is difficult to measure a spacing smaller than that level. Therefore, a further improved measurement apparatus which can measure a still smaller spacing has been proposed (e.g., JP H8-507384A and JP H10-267623A).

In recent high recording density media, the surface of the magnetic layer is finished considerably smooth so as to improve short-wavelength recording characteristics, and a spacing between a magnetic tape and a head has become considerably small. Therefore, it has become necessary to measure a spacing of several tens of nanometers to 10 nm or less.

However, regarding interference light measurement, the technique proposed in JP H8-507384A for calibrating the intensity and determining the order of interference fringes, can measure a spacing of about no less than several tens of nanometers and has difficulty in measuring a spacing smaller than that level.

In the case of the technique proposed in JP H10-267623A for analyzing a change in light intensity in consideration of the spectral intensity distribution of illumination light when a minute distance is measured using the interference light as a reference, it is also difficult to measure a spacing of 100 nm or less.

Therefore, in these techniques, it is difficult to measure a spacing with respect to recent high density recording media which require measurement of a spacing of, for example, 10 nm or less.

The present invention is provided so as to solve the conventional problems as described above. An object of the present invention is to provide an apparatus and a method for measuring a minute spacing of, for example, 10 nm or less.

### SUMMARY Of THE INVENTION

In order to achieve the object, the present invention provides an apparatus for measuring a spacing between an object to be measured and a transparent object, in which the transparent object is disposed, fading a surface of the object to be measured, light is emitted to impinge through the transparent object onto the object to be measured, and the spacing is calculated based on an intensity of interference light occurring in a facing portion between the surface of the object to be measured and the transparent object. The apparatus comprises a light source for emitting light, a modulator for modulating an intensity of the emitted light with modulation waves having a predetermined frequency, a sensor for converting the light intensity of the interference light into an electrical signal, and a synchronous demodulator for subjecting the electrical signal to synchronous demodulation using the modulation waves as reference waves.

The present invention also provides a method for measuring a spacing between an object to be measured and a transparent object, in which the transparent object is disposed, facing a surface of the object to be measured, light is emitted to impinge through the transparent object onto the object to be measured, and the spacing is calculated based on an intensity of interference light occurring in a facing portion between the surface of the object to be measured and the transparent object. The method comprises modulating an intensity of the emitted light with modulation waves having a predetermined frequency, converting the light intensity of the interference light into an electrical signal, and subjecting the electrical signal to synchronous demodulation using the modulation waves as reference waves.

### BRIEF DESCRIPTION OF THE DRAWINGS

FIG. 1 is a diagram showing a configuration of a spacing measuring apparatus according to Embodiment 1 of the present invention.

FIG. 2 is a diagram showing emitted light which has been intensity-modulated according to an embodiment of the present invention.

FIG. 3 is an enlarged view of a vicinity of a portion where a simulated head 4 and a magnetic tape T face each other according to an embodiment of the present invention.

FIG. 4 is a conceptual diagram showing a comparative example of a relationship between spacings and a waveform of an electrical signal of interference light.

FIG. 5 is a diagram showing a relationship between spacings and interference light intensities according to an embodiment of the present invention.

FIG. 6 is a diagram showing a configuration of a spacing measuring apparatus according to Embodiment 2 of the present invention.

FIG. 7 is a diagram showing an exemplary configuration of a conventional spacing measuring apparatus.

### DETAILED DESCRIPTION OF THE INVENTION

According to the present invention, the intensity of light is modulated with modulation waves of a predetermined frequency before being emitted, and the intensity of occurring interference light is subjected to synchronous demodulation using the modulation waves as reference waves. Therefore, a noise component can be minimized which otherwise becomes large when a minute spacing of for example, 10 nm or less is measured. thereby making it possible to measure a spacing with high precision.

In the spacing measuring apparatus and the spacing measuring method of the present invention, the frequency of the modulation waves is preferably within the range of 10 Hz or more and 1000 Hz as less. With this configuration, the noise reduction effect is significant and it is easy to perform synchronous demodulation.

The frequency of the modulation waves is preferably 10 Hz or more and 1000 Hz or less, more preferably 30 Hz or more and 500 Hz or less. This is because, when the frequency of the modulation waves is smaller than 10 Hz, the noise reduction effect of synchronous demodulation described below is small, and when the frequency of the modulation waves exceeds 1000 Hz, it is difficult to perform synchronous demodulation itself.

The spacing preferably includes a surface roughness of the object to be measured.

The spacing measuring apparatus of the present invention preferably further comprises a splitter for splitting an optical path of the interference light, and wavelength selector corresponding to the respective split optical paths. The sensor preferably corresponds to each wavelength selector. The wavelength selector preferably converts light beams on the respective split optical paths into monochromatic light beams having different wavelengths. The sensor preferably converts light intensities of the respective monochromatic light beams into electrical signals

In the spacing measuring method of the present invention, converting the light intensity of the interference light into the electrical signal preferably includes converting the interference light into monochromatic light beams having different wavelengths and converting the monochromatic light beams into respective electrical signals.

With the above-described configuration in which a plurality of monochromatic light beams are used, the range of a spacing which is supposed to be measured can he expanded.

Hereinafter, an embodiment of the present invention will be described with reference to the accompanying drawings.

### EMBODIMENT 1

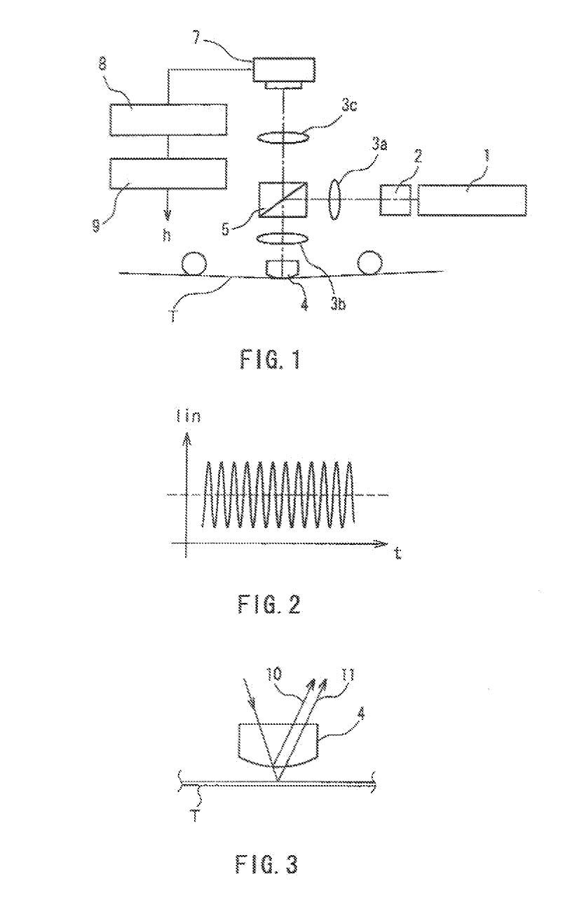

FIG. 1 is a diagram showing a configuration of a spacing measuring apparatus according to Embodiment 1 of the present invention. The spacing measuring apparatus of FIG. 1 measures a spacing between a simulated head 4 which is a transparent object formed of a light transmitting material, and a magnetic tape T which is an object to be measured which is disposed facing the simulated head 4.

The simulated head 4 is formed in the same shape as that of an actual magnetic head by processing a transparent material, such as silica glass (BK7). The traveling speed of the magnetic tape T can be adjusted by a traveling speed controller (not shown).

The magnetic tape T is caused to travel while being guided by a guide or the like (not shown). According to settings of the guide or the like, a travel path and a travel tension which is the tension of the magnetic tape T during traveling are determined. The spacing between the simulated head 4 and the magnetic taps T can be changed by changing the traveling speed, the travel path, and the travel tension. The spacing is also changed, depending on the shape of a surface facing the magnetic tape T of the simulated head 4.

A light source 1 emits, for example, He—Ne laser (wavelength: 683 nm). The emitted light is intensity-modulated with modulation waves having a predetermined frequency by an optical module 2 which is a modulator.

FIG. 2 is a diagram showing the emitted light which has been intensity-modulated. As shown in FIG. 2, the intensity Iin of the emitted light varies its a sine-wave pattern. The intensity-modulated light is emitted toward the simulated head 4.

More specifically, the emitted light (e.g., He—He laser (wavelength; 633 nm)) from the light source 1 is intensity-modulated with modulation waves having a predetermined frequency by the optical module 2 which is a modulator comprised of two polarizing plates which are relatively repeatedly rotated back and forth within a predetermined angular range with a predetermined rotational speed.

The optical module 2 in this case comprises two polarizing plates provided on the same axis, for example. One of the two polarizing plates is connected to a pulse motor so that the polarizing plate is driven and rotated. By inputting a modulation signal to the pulse motor, the polarizing plate connected to the pulse motor is repeatedly rotated back and forth within the predetermined angular range with the predetermined rotational speed.

Note that the optical module 2 above is only for illustrative purposes and the present invention is not limited to this. Any means capable of intensity-modulating the emitted light may be used. For example, the polarizing plate may be continuously rotated in a single direction by a motor instead of repetitive back-and-forth rotation.

The frequency of the modulation waves is preferably 10 Hz or more and 1000 Hz or less, more preferably 30 Hz or more and 500 Hz or less. This is because, when the frequency of the modulation waves is smaller than 10 Hz, a noise reduction effect of synchronous demodulation described below is small, and when the frequency of the modulation waves exceeds 1000 Hz, it is difficult to perform synchronous demodulation itself.

In FIG. 1, the emitted light intensity modulated by the optical module 2 is passed through an optical lens 3a and is then bent by 90 degrees by a half mirror 5. The bent light is passed through an optical lens 3b and is then brought through the simulated head 4 onto the magnetic tape T.

FIG. 3 is an enlarged view of a vicinity of a portion where the simulated head 4 and the magnetic tape T face each other. Reflected light 10 from the surface, facing the magnetic tape T of the simulated head 4 and reflected light 11 from a surface of the magnetic tape T interfere with each other, resulting in interference light having an intensity Iout. The interference light is transferred through the optical lens 3b, the half mirror 5, and an optical lens 3c to a CCD camera 7 which is a sensor. The interference light which has reached the CCD camera 7 is converted into an electrical signal.

Note that the CCD camera 7 is an exemplary sensor. The sensor is not limited to CCD cameras. Any known light receiving elements can be used.

As described above, since the emitted light is intensity modulated with modulation waves having a predetermined frequency, the electrical signal obtained by the CCD camera 7 is also an intensity-modulated signal.

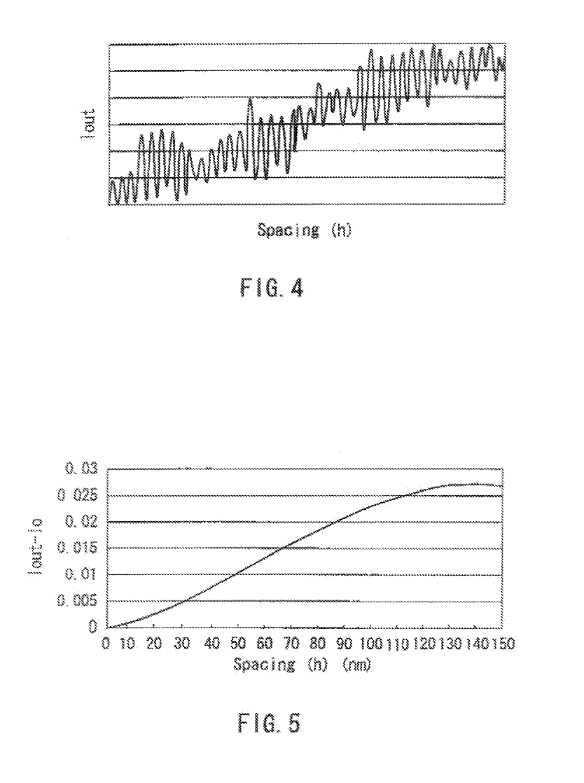

FIG. 4 is a conceptual diagram showing a relationship between spacings and a waveform of an electrical signal of interference light (comparative example). The waveform of FIG. 4 increases to the right as a whole, i.e., as the spacing increases, the intensity of the interference light increases. In this case, if the waveform of an electrical signal corresponding to spacings is free from noise as in the waveform of FIG. 2, the correct intensity Iout can be obtained.

However, the waveform of FIG. 4 is different from that of FIG. 2, and is irregular, depending on the spacing. Therefore, it is difficult to uniquely determine the intensity Iout with respect to each spacing.

In this embodiment, noise is removed by synchronous demodulation, thereby obtaining the correct intensity Iout. Specifically, the electrical signal obtained by the CCD camera 7 is subjected to synchronous demodulation using the modulation waves of FIG. 2 as reference waves. Thereby, noise other than the frequency of the modulation waves is cut off from the electrical signal obtained by the CCD camera 7, so that a correct electrical signal free from noise is obtained.

Referring back to FIG. 1, the electrical signal obtained fey the CCD camera 7 is input to a lock-in amplifier 8 which is a synchronous demodulator. In the lock-in amplifier 8, the electrical signal obtained by the CCD camera 7 is subjected to synchronous demodulation using the modulation waves of FIG. 2 as reference waves. Thereby noise other than the frequency of the modulation waves is cut off from the electrical signal, so that a correct interference light intensity is obtained. More specifically the intensity has a constant center value, though it varies periodically. Therefore, in the waveform of the electrical signal converted from the interference light, an average value of the maximum value and the minimum value can be set as the intensity Iout of the interference light.

The obtained interference light intensity is input to an operation apparatus 9. In the operation apparatus 9, based on a relational expression between interference light intensities and spacings described below, a spacing h corresponding to the input interference light intensity is calculated.

Next, a process of obtaining a spacing from an interference light intensity will be specifically described. The light intensity ratio Iout/Iin of the intensity Iin of the emitted light and the intensity Iout of the interference light is represented by:

$$\begin{matrix}\frac{{I}_{out}}{{I}_{i n}} = \frac{{r}^{2} + {s}^{2} + 2 rs cos δ}{1 + {r}^{2} {s}^{2} + 2 rs cos δ} & ( 1 ) \\ δ = ( 4 π h / λ ) - φ & ( 2 )\end{matrix}$$

where h represents the spacing, λ represents the wavelength of light emitted toward the simulated head 4, r represents the reflectance of the surface facing the magnetic tape T of the simulated head 4, s represents the reflectance of the surface of the magnetic tape T, and φ represents a delay in phase due to reflection on the surface of the magnetic tape T. The reflectance r of the transparent object of the simulated head 4, the surface reflectance s of the magnetic tape T, and the phase difference φ can he obtained by measurement in advance. Therefore, if Iout is measured, the spacing h can be calculated from expressions (1) and (2). As described above, in this embodiment, Iout can be correctly obtained by the removal of noise by synchronous demodulation. Therefore, the spacing h calculated from expressions (1) and (2) also has a correct value.

FIG. 5 is a diagram showing a relationship between the spacing h and Iout, where Iout is obtained from expressions (1) and (2), assuming that Iin is 1. Note that, for the sake of simplicity, it is assumed that the value of the y axis (vertical axis) is zero when the spacing h is zero. Specifically, the value of the y axis is assumed to be Iout-I₀ where I₀ is Iout when h=0.

The relationship of FIG. 5 is derived, assuming that the wavelength λ of the emitted light=633 nm, the reflectance r of the simulated head 4=0.04, the surface reflectance s of the magnetic tape T=0.18, and the phase delay φ=1.77 degrees.

As can be seen from FIG. 5, as the spacing increases from h=0, the interference light intensity increases. When the spacing is in the vicinity of about ¼ of the wavelength of the light source used, the maximum intensity of Iout is obtained. Thereafter, Iout turns into a decrease. When the spacing is at the next ¼ of the wavelength, the minimum intensity is obtained. When the spacing is at the further next ¼ of the wavelength, the maximum intensity is obtained. In this manner, the maximum intensity is repeated at pitches of ½ of the wavelength. In FIG. 5, the waveform after ¼ of the wavelength is not shown.

As can be seen from FIG. 5, when a spacing smaller than ¼ of the wavelength is measured, the interference light intensity decreases with a decrease in the spacing. Therefore, as the spacing decreases, the difference between Iout and I₀ decreases without limit.

Therefore, when a spacing smaller than several tens of nanometers is measured, the output of the electrical signal based on the intensity of the interference light becomes considerably small, so that noise becomes relatively large. Therefore, in the conventional apparatus as shown in FIG. 7, the measurement limit of a spacing is about several tens of manometers. In the present embodiment, however, noise can be removed from a minute electrical signal by synchronous demodulation as described above, which is advantageous for measurement of a minute spacing, thereby making it possible to measure a spacing of, for example, 10 nm or less.

### EMBODIMENT 2

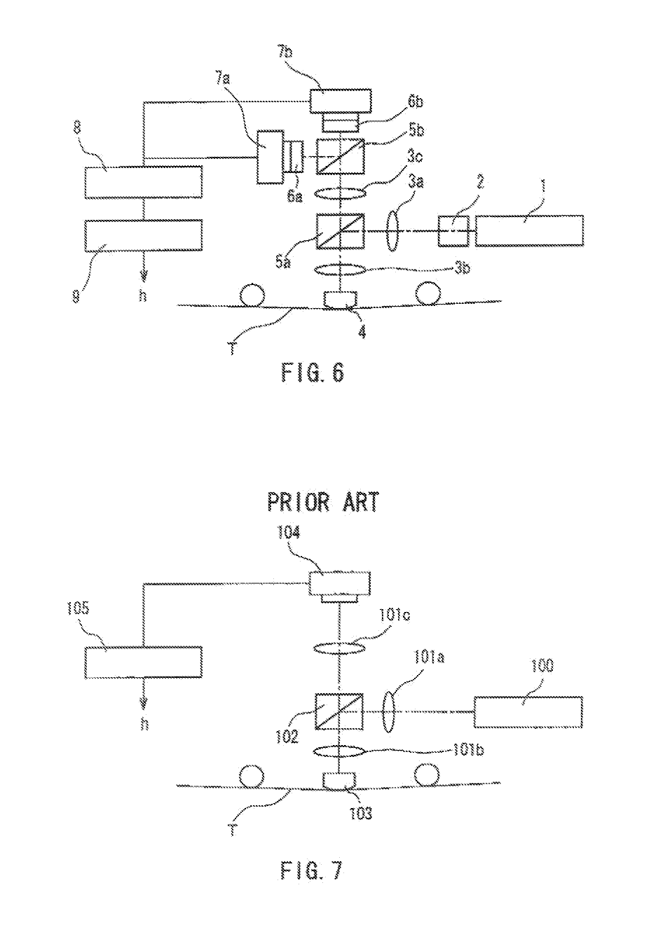

FIG. 6 is a diagram showing a configuration of a spacing measuring apparatus according to Embodiment 2 of the present invention. In Embodiment 1, an exemplary spacing measuring apparatus employing light having a single wavelength has been described. The configuration of FIG. 6 is as exemplary application of Embodiment 1, in which light having two wavelengths is employed. In FIG. 6, the same parts as those of FIG. 1 are indicated by the same reference numerals and will not be described in detail.

In this embodiment, a white light source, such as a halogen lamp, is used as the light source 1. Light emitted from the light source 1 is passed through the optical module 2, the optical lens 3a, the half mirror 5a, and the optical lens 3b and is then brought through the simulated bead 4 onto the magnetic tape T. Interference light of reflected light from the surface facing the magnetic tape T of the simulated head 4 and reflected light from the surface of the magnetic tape T is passed through the optical leas 3b, the half mirror 5a, and the optical lens 3c. The above-described parts are the same as those of Embodiment 1.

The light which has been passed through the optical lens 3c is split into two optical paths by a half mirror 5b which is a splitter. The interference light on one of the optical paths is converted into monochromatic light (e.g., red) by a wavelength selecting transmission filter 6a which is a wavelength selector. The resultant monochromatic light reaches a CCD camera 7a which is a sensor. The interference light on the other optical path is converted into monochromatic light (e.g. green) by a wavelength selecting transmission filter 6b which is a wavelength selector having a transmission wavelength different from that of the wavelength selecting transmission filter 6a. The resultant monochromatic light reaches a CCD camera 7b which is a sensor.

The interference light beams which have reached the CCD cameras 7a and 7b are converted into electrical signals. The electrical signals are input to the lock-in amplifier 8 and are subjected to synchronous demodulation. Thereafter, the spacing h is calculated by the operation apparatus 9.

As described in Embodiment 1 with reference to FIG. 5, the maximum intensity of Iout is obtained when the spacing is in the vicinity of ¼ of the wavelength of the emitted light of the light source used, and thereafter, Iout turns into a decrease. In this case, a plurality of spacing values correspond to one intensity. Therefore, in the example of FIG. 5, it is assumed that the spacing of an object to be measured is about 150 nm or less. Although the measurement range can be expanded to about 150 nm or more, the range of the spacing of an object to be measured needs to be roughly known in advance.

In this embodiment, since two interference light beams corresponding to the different wavelengths are obtained, two curves having a phase difference are obtained (each curve is as shown in FIG. 5). Therefore, even when two spacing values correspond to one intensity, it is possible to determine which of the spacing values is an actual value by comparing as intensity difference between the two interference light beams of the different wavelengths corresponding to one of the spacings with an intensity difference between the two interference light beams of the different wavelengths corresponding to the other spacing.

In other words, according to this embodiment, by using two interference light beams having different wavelengths, the range of a spacing which is supposed to be measured can be expanded.

Note that, as described in Embodiment 1, the present invention is advantageous for measurement of a minute spacing of, for example, 10 nm or less. Therefore, the configuration of Embodiment 1 of FIG. 1 is suitable for measurement of a spacing within such a minute range.

Although it has been described, in Embodiments 1 and 2 that a spacing between the simulated head 4 and the magnetic tape T is measured when the traveling speed, the travel path, and the travel tension are changed while the magnetic tape T is being caused to travel, a spacing can also be measured when the shape of the surface facing the magnetic tape T of the simulated head 4 is changed.

Also, as described above, the present invention is suitable for measurement of a urinate spacing of, for example, 10 nm or less. The object to be measured is not limited to magnetic tapes.

It is also possible to measure a surface roughness of a still (flexible) object to be measured by contacting a transparent object to the object to be measured and measuring a spacing of each portion of the contact surface.

As described above, according to the present invention, a minute spacing of, for example, 10 nm or less can he measured. Therefore, the present invention is useful for measurement of a spacing between a high recording density magnetic tape and a head, for example.

The above-described embodiments are considered, in all respects as illustrative and not restrictive. The scope of the invention is indicated by the appended claims rather than by the foregoing description. All changes which come within, the meaning and range of equivalency of the appended claims are intended to he embraced therein.

What is claimed is:

1. An apparatus for measuring a spacing between an object to be measured and a transparent object, wherein the transparent object is disposed, facing a surface of the object to be measured, light is emitted to impinge through the transparent object onto the object to be measured, and the spacing is calculated based on an intensity of interference light occurring in a facing portion between the surface of the object to be measured and the transparent object, the apparatus comprising:
a light source for emitting light;
a modulator for modulating an intensity of the emitted light with modulation waves having a predetermined frequency;
a sensor for converting the light intensity of the interference light into an electrical signal; and
a synchronous demodulator for subjecting the electrical signal to synchronous demodulation using the modulation waves as reference waves.

2. The apparatus according to claim 1, wherein the frequency of the modulation waves is within the range of 10 Hz or more and 1000 Hz or less.

3. The apparatus according to claim 1, wherein the spacing includes a surface roughness of the object to be measured.

4. The apparatus according to claim 1, further comprising:
a splitter for splitting an optical path of the interference light; and
wavelength selector corresponding to the respective split optical path,
wherein the sensor corresponds to each wavelength selector, the wavelength selector converts light beams on the respective split optical paths into monochromatic light beams having different wavelengths, and the sensor converts light intensities of the respective monochromatic light beams into electrical signals.

5. A method for measuring a spacing between an object to be measured and a transparent object, wherein the transparent object is disposed, facing a surface of the object to be measured, light is emitted to impinge through the transparent object onto the object to be measured, and the spacing is calculated based on an intensity of interference light occurring in a facing portion between the surface of the object to be measured and the transparent object, the method comprising:
modulating an intensity of the emitted light with modulation waves having a predetermined frequency;
converting the light intensity of the interference light into an electrical signal; and
subjecting the electrical signal to synchronous demodulation using the modulation waves as reference waves.

6. The method according to claim 5, wherein the frequency of the modulation waves is within the range of 10 Hz or more and 1000 Hz or less.

7. The method according to claim 5, wherein the spacing includes a surface roughness of the object to be measured.

8. The method according to claim 5, wherein converting the light intensity of the interference light into the electrical signal includes converting the interference light into monochromatic light beams having different wavelengths and convening the monochromatic light beams into respective electrical signals.
